(19) United States
(12) Patent Application Publication
(10) Pub. No.: US 2015/0273665 A1
(43) Pub. Date: Oct. 1, 2015

(54) WRENCH, DRAIN RETAINER NUT

(71) Applicant: DICK L. THOMAS, SALEM, OR (US)

(72) Inventor: DICK L. THOMAS, SALEM, OR (US)

(21) Appl. No.: 14/228,907

(22) Filed: Mar. 28, 2014

(51) Int. Cl. B25B 13/08; B25B 13/50; B25B 13/48

(52) U.S. Cl. CPC B25B 13/08; B25B 13/481; B25B 13/50

(57) ABSTRACT

A multi-purpose, extensible, open ended wrench having hexagonal, and/or notched sides used for engaging, loosening or tightening a plurality of various sink and shower drain lock nut designs. Said wrench further has a square hole opposite the open end for insertion of a socket drive handle, and/or extension, to apply torque to a retainer nut and allow access to remote sites. The narrow width of the tool allows for access through small openings in flooring and in locations with little or no other access. The wrench eliminates the need to remove drain pipes, sinks or showers in order to access the drain locknuts.

### REFERENCE SITED

U.S. PATENT DOCUMENTS

| | | |
|---|---|---|
| 6,805,029 | OCT. 12, 2004 | FOSTER et al. |
| 7,788,994 | Sep. 7, 2010 | WRIGHT et al. |
| 5,946,990 | Sep. 7, 1999 | BONACCI |
| 4,688,454 | Aug. 25, 1987 | Scull |
| 7,562,605 | Jul. 21, 2009 | Kunkel et al. |

Current U.S. Class: 81/119; 81/177.8
Current International Class: B25B 13/00 (20060101); B25B 13/08 (20060101); B25B 13/48 (20060101); B25B 013/02 0; B25B 023/16 ( )
Field Search 81/119, 121, 176.1, 176.15, 176.2, 177.1

### BRIEF DESCRIPTION OF THE DRAWINGS

The accompanying drawings, which are incorporated in and form a part of the specification, illustrate the embodiments of the present invention and, together with the written description, serve

to explain the principles, characteristics, and features of the invention. In the drawings:

FIG. 1 is a top view of my design;

FIG. 2 is an oblique view of my design;

FIG. 3 is a left side view of my design;

FIG. 4 is an end view of my design;

FIG. 5 is an annotated view of the top view

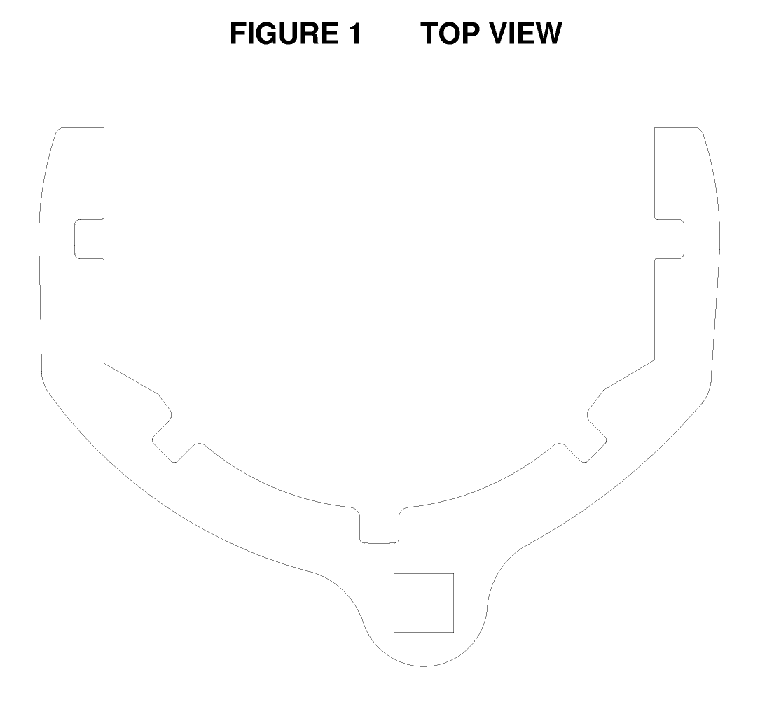

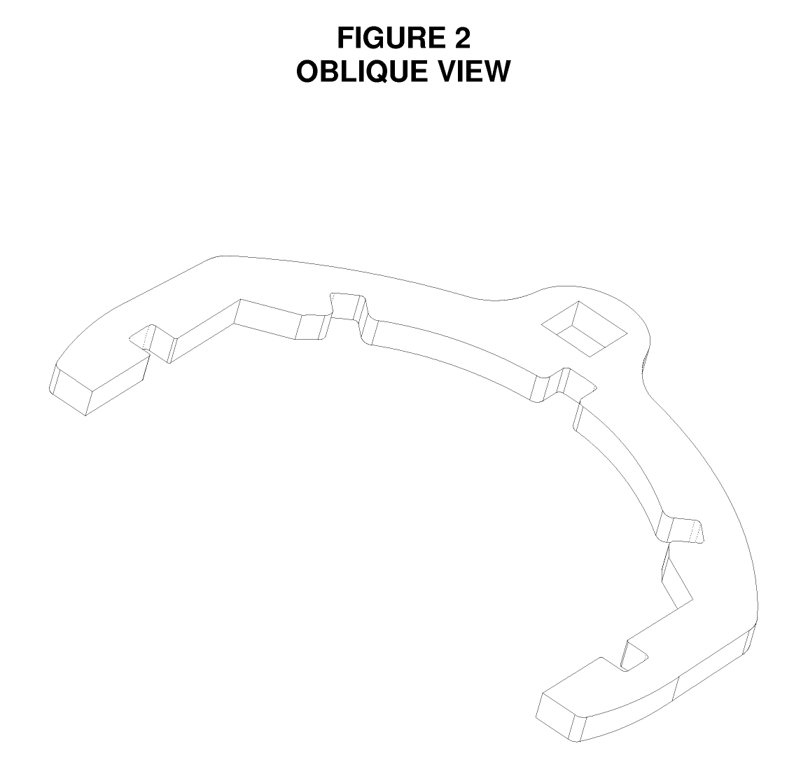

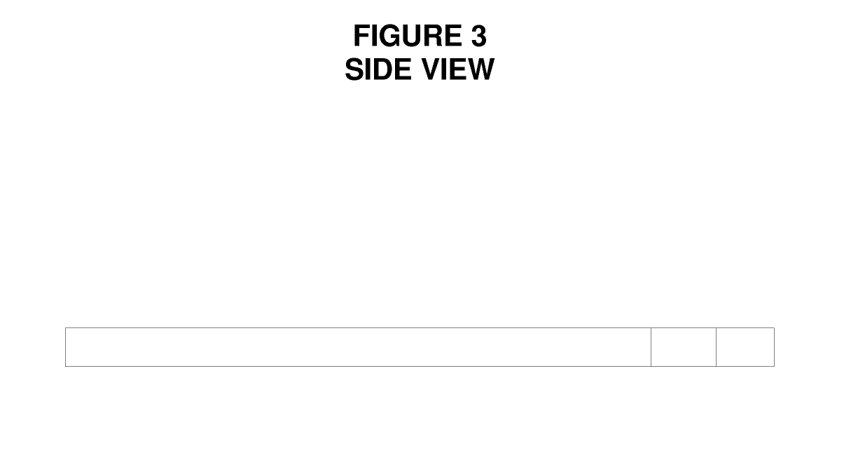

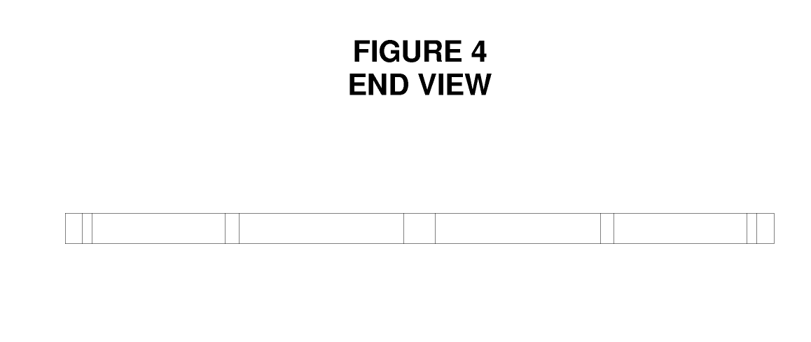

### DESCRIPTION

### Field of the Invention

This invention relates to wrenches and in particular, open end wrenches and more particular wrenches with fixed jaws and even more particular wrenches used for turning retainer nuts, associated with, but not limited to, sink and shower drains. This invention is not limited in scope or design and may be used to fit other nuts of various configurations and specifications.

### Description of Prior Art

Typical plumbing drain wrenches have been designed for installing sink and shower drains where copious amounts of space are present. Tools for removing the drain retainer nuts do not normally allow for access when there is no lateral clearance around the drain or where the drain pipes cannot be removed, or the plumber does not want to remove the pipes, because of installation or design irregularities. In such situations the use of screwdrivers and hammers incorporated to drive the nut loose, or tighten the nut, often damage the lock nut or render it useless for further use as a retainer nut.

The typically used wrench does not allow use on retainer nuts of different designs. For example: tabbed lock nuts and hexagonal nuts. Hexagonal nuts, especially, cannot be loosened in space deprived areas because there are no wrenches that allow for vertical access to the shower drain without having to remove the shower and/or cutting the drain pipe. Consequently, it is desirable to provide a wrench for the removal, or replacement, of drain retainer nuts, of various designs, to rectify these installation inadequacies and inadequacies of the prior art.

### DETAILED DESCRIPTION

An open-ended wrench for use on a multi-sided member of selected size, comprising:

Two parallel jaws (S1, S2)

Two gripping flat surfaces (S3 & S4) which are convergent from (S1 & S2) at 30 degree angles and of given length (L2). Said sides S1, S2, S3, and S4, are for engaging a hexagonal retainer nut.

Further, the two parallel jaws, S1 and S2, have 1 each, coinciding, groove (G1,G2) perpendicular with, and positioned mid-way to, the length of S1 & S2 and shaped such as to engage one tab each of a four or eight sided, tabbed, retainer nut.

At the opposite end of the wrench opening is end (C). End (C) and that portion of the body of the wrench from (C) to S3 and (C) to S4 have an arced shape coincident with the circumferential arc of a tabbed retainer nut. A shaped groove, (G5), is positioned at end point (C) and engages a third tab of a four or eight sided, tabbed, retainer nut. End (C) is used to engage a corner of the hexagonal retainer nut captured by (S1, S2, S3, and S4).

The flat surfaces of (S3 & S4) have 1 each coinciding shaped groove, (G3 & G4) which, along with (G1, G2, and G5), engage the tabs of an eight sided, tabbed, lock nut.

All grooves, (G1, G2, G3, G4, & G5) are position crosswise (perpendicular) to all flat surfaces and perpendicular with the plane of rotation of the wrench.

The plane of rotation of the wrench is parallel with the plane of rotation of the retainer nut.

At a point opposite the wrench opening and at a point across from the end (C) on the body of the wrench at (B3) is a square lug aperture (H). Said lug aperture (H) is used for and, is of such size as to allow for, the insertion of a square socket lug which is part of a socket wrench handle and/or extension, perpendicular to the plane of rotation of the wrench, for the purpose of applying torque to the retainer nut in order to loosen or tighten said nut.

### SUMMARY

The present invention provides a wrench for installation and removal of, and free access to, retainer nuts which, by their placement, have limited access.

The body of the wrench includes a shaped aperture configured to engage the retainer nuts of various, commonly used, sink and shower drains and a square lug aperture.

The shaped aperture is configured such as to engage commercially available tab style retainer nuts and hexagonal retainer nuts.

The square lug aperture is dimensioned to allow the use of normally available socket wrenches and drive extensions with square lugs. Typically ⅜ inch and ½ inch drive lugs.

The configuration and advantages of the invention will become apparent to anyone, skilled in the art, upon examination of the following drawings.

1. A drain retainer nut tool for use with multiple drains of different styles of drains. A first style of drain includes tabbed retainer nuts. A second style of drain includes drains with hexagonal retainer nuts.

2. An open ended, fixed jaw wrench comprising two parallel jaws and two, convergent, surfaces which engage the sides of the second style, hexagonal, retainer nut of claim one.

3. Further, the embodiment of the tool in claim 2 has five shaped apertures configured such that they engage the tabs of four or eight tabbed nuts of the first style, tabbed, retainer nuts in claim 1.

4. The embodiment in claim 3 is configured such as to conform to the circumference of the first style nut in claim one.

5. The jaws and embodiment of claim 2 are narrow to allow operation in areas of limited access.

6. The open jaws of the tool in claim 2 allow for use without necessitating the removal of drain pipes.

7. The embodiment of the tool, in claim 2, has a square shaped aperture, opposite the open end, which allows insertion of a square lug from a socket wrench or socket extension which is then used to rotate the retainer nut for either loosening or tightening said retainer nut.
